(19) United States
(12) Patent Application Publication
(10) Pub. No.: US 2024/0106114 A1
(43) Pub. Date: Mar. 28, 2024

(54) RADIO DEVICE AND CONTROL METHOD THEREOF

(71) Applicant: MEDIATEK Inc., Hsin-Chu (TW)

(72) Inventors: Shih-Wei HSIEH, Hsinchu City (TW); Wei-Hsuan CHANG, Hsinchu City (TW); Chih-Wei LEE, Hsinchu City (TW); Shyh-Tirng FANG, Hsinchu City (TW)

(21) Appl. No.: 17/935,147

(22) Filed: Sep. 26, 2022

(51) Int. Cl. H01Q 3/36; H01Q 3/06

(52) U.S. Cl. CPC H01Q 3/36; H01Q 3/06; H04B 17/318

(57) ABSTRACT

A radio device includes a first antenna array and an actuator. The first antenna array is configured to transmit a radiation beam to a remote device. The actuator is configured to change an orientation of the first antenna array, whereby a beam direction of the radiation beam is changed according to a change of the orientation of the first antenna array. The beam direction of the radiation beam is adjusted according to a beam steering mechanism performed by the first antenna array.

### TECHNICAL FIELD

The present disclosure relates to a radio device and a control method thereof, and more particularly, relates to a radio device for performing wireless communication and a control method for adjusting radiation beam of the radio device.

### BACKGROUND

Radio devices, such as mobile phones or panel tablets, usually provide a capability of wireless communication. To perform wireless communication with a remoted device (such as a base station), radio devices are equipped with antennas to transmit and receive radio frequency (RF) signals to and from the remote device. RF signals are carried in a radiation beam of the antennas.

Antenna array, which includes a group of phase-array antenna elements, function to execute beam steering mechanism for the radiation beam, with which a beam direction of the radiation beam is adjusted. However, beam steering mechanism merely provides one dimension of adjustment for beam direction, which cannot achieve a full spherical coverage. Hence, a radio device needs to equip two or more antenna arrays, disposing these antenna arrays in different directions (such as, in two directions perpendicular to each other) so as to achieve better spherical coverage.

Nevertheless, to dispose a greater amount of antenna arrays in a radio device, cost will be significantly increased. Furthermore, the greater amount of antenna arrays will occupy more space in the radio device, which is unfavorable for arrangement of other circuit elements.

In view of the afore-mentioned issues, it is desirable to have an improved radio device and control method thereof, in which a single antenna array is equipped, and radiation beam of the single antenna array is efficiently controlled to achieve full spherical coverage.

### SUMMARY

According to an aspect of the present disclosure, a radio device is provided. The radio device includes a first antenna array and an actuator. The first antenna array is configured to transmit a radiation beam to a remote device. The actuator is configured to change an orientation of the first antenna array, whereby a beam direction of the radiation beam is changed according to a change of the orientation of the first antenna array. The beam direction of the radiation beam is adjusted according to a beam steering mechanism performed by the first antenna array.

According to an aspect of the present disclosure, a control method is provided. The control method is for controlling a radiation beam of a radio device, the radio device includes a first antenna array to transmit the radiation beam to a remote device. The control method includes the following. Controlling an actuator to change an orientation of the first antenna array, whereby a beam direction of the radiation beam is changed according to a change of the orientation of the first antenna array. Controlling the first antenna array to perform a beam steering mechanism to adjust the beam direction of the radiation beam.

### BRIEF DESCRIPTION OF THE DRAWINGS

FIG. 1 is a schematic diagram of a radio device according to an example of the disclosure.

FIG. 2A is an enlarged view of the actuator and the first antenna array of FIG. 1.

FIG. 2B is a cross-sectional view of the actuator and the first antenna array of FIG. 2A.

FIG. 3 is a schematic diagram of the radio device, in which the first antenna array is adjusted to rotate along the first axis.

FIG. 4A is an enlarged view of the actuator and the first antenna array of FIG. 3.

FIG. 4B is a cross-sectional view of the actuator and the first antenna array of FIG. 4A.

FIG. 5 is a block diagram illustrating signal flow of the radio device and the remote device.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically illustrated in order to simplify the drawing.

### DETAILED DESCRIPTION

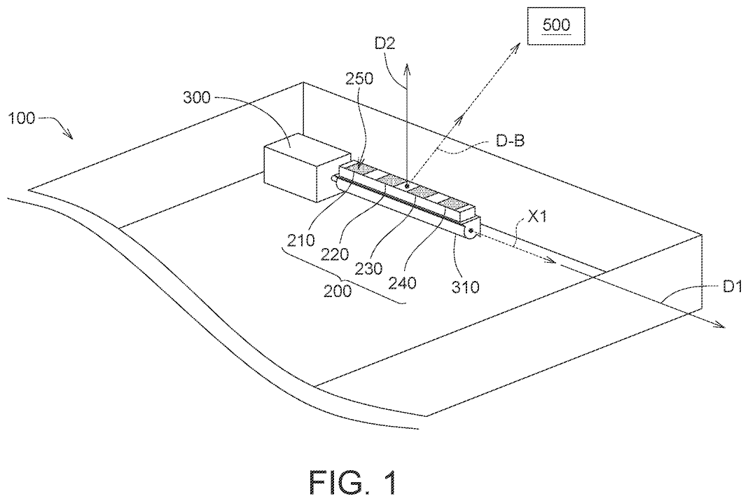

FIG. 1 is a schematic diagram of a radio device 100 according to an example of the disclosure. Referring to FIG. 1, the radio device 100 functions to perform wireless communication with a remote device 500. The radio device 100 is, for example, a portable computing device such as a mobile phone or a panel tablet. On the other hand, the remote device 500 is, for example, a base station. The radio device 100 is configured to transmit and receive a radio frequency (RF) signal to and from the remote device 500.

The radio device 100 includes a first antenna array 200. The first antenna array 200 is configured to transmit a radiation beam to the remote device 500, and the RF signal RS1 is carried in the radiation beam. A beam direction D-B of the radiation beam is directed toward the remote device 500.

Furthermore, the radio device 100 includes an actuator 300. The actuator 300 is configured to adjust the first antenna array 200. For example, the actuator 300 is configured to change an orientation and/or a position of the first antenna array 200. The actuator 300 is, for example, a motor, which is configured to change the orientation of the first antenna array 200. The actuator 300 is coupled to a rotating portion 310, and actuator 300 drives the rotating portion 310 to rotate along a first axis X1. The first axis X1 is parallel to a first direction D1. The first antenna array 200 is disposed on the rotating portion 310, so that the rotating portion 310 may carry the first antenna array 200 to rotate along a first axis X1. Based on the above, the actuator 300 is configured to change the orientation of the first antenna array 200 so that the first antenna array 100 rotates along a first axis X1 parallel to the first direction D1.

Moreover, the first antenna array 200 includes a group of antenna elements 210, 220, 230 and 240. The group of antenna elements 210-240 are arranged to extend in the first direction D1. The group of antenna elements 210-240 have a radiation end 250 facing toward a second direction D2. The second direction D2 is perpendicular to the first direction D1. The group of antenna elements 210-240 are phase-array antenna elements configured to perform a “beam steering” mechanism. With the beam steering mechanism, the group of antenna elements 210-240 may adjust the beam direction D-B of the radiation beam. For example, with the beam steering mechanism the beam direction D-B may be adjusted along a plane (not shown in FIG. 1) defined by the first direction D1 and the second direction D2.

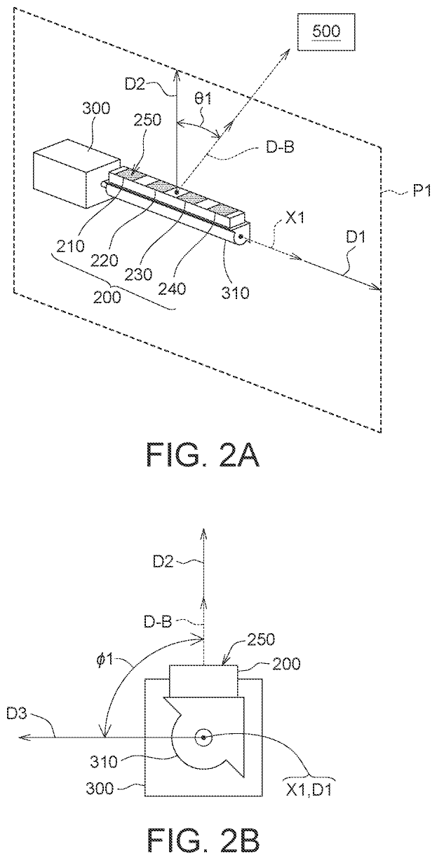

FIG. 2A is an enlarged view of the actuator 300 and the first antenna array 200 of FIG. 1. FIG. 2A is taken as a reference to illustrate the beam steering mechanism to adjust the beam direction D-B of the radiation beam transmitted by the first antenna array 200. Referring to FIG. 2A, a plane P1 is defined by the first direction D1 and the second direction D2. The beam direction D-B may be adjusted along the plane P1. The beam direction D-B has an angle θ1 with respect to the second direction D2. With the beam steering mechanism, the angle θ1 is adjusted in a first range. For example, the first range is from −60 degree to 60 degree.

The beam direction D-B of the radiation beam may be adjusted according to a power of the RF signal RS1 from the remoted device 500, so that the radio device 100 may receive or transmit the RF signal RS1 with maximum power. For example, the power of the RF signal RS1 from the remote device 500 is evaluated with “Received Signal Strength Indication” (RSSI) and “Reference Signal Receiving Power” (RSRP). The beam direction D-B is adjusted according to the RSSI and/or the RSRP related to the radio device 100 and the remote device 500. For example, the angle θ1 between the beam direction D-B and the second direction D2 is adjusted so as to achieve better RSSI or RSRP.

Now referring to Tables 1-1 and 1-2 listed below, which describes an example of beam steering mechanism performed by the first antenna array 200. Each of the antenna elements 210, 220, 230 and 240 of the first antenna array 200 has a vertical polarization or a horizontal polarization. The antenna elements 210, 220, 230 and 240 with vertical polarization (i.e., “UE V”) are denoted as “0, 1, 2, 3” in the second column of Table 1-1. The antenna elements 210, 220, 230 and 240 with horizontal polarization (i.e., “UE H”) are denoted as “4, 5, 6, 7” in the second column of Table 1-1. Furthermore, the antenna elements 210-240 are phase-array antenna elements. With various phase-combination, the antenna elements 210-240 may steer the radiation beam, so that the radiation beam may have different beam direction D-B.

For example, referring to the third column of Table 1-1, with a set of phase-combination of “0, 0, −135, −135, 0, −315, −180, −135”, the antenna elements 210-240 may steer the radiation beam as “Beam ID=1” so that radiation beam has a desired beam direction D-B. Hence, the angle θ1 between the beam direction D-B and the second direction D2 achieves a desired value. Likewise, referring to the fourth column of Table 1-1, the antenna elements 210-240 may steer the radiation beam as “Beam ID=2” by another set of phase-combination of “0, −45, −225, −270, 0, 0, −180, −225”, so that radiation beam is steered as another desired beam direction D-B with desired angle θ1. In the example of Table 1-1, with 8 sets of phase-combinations, the antenna elements 210-240 provide mean beams of 8 different beam directions, which are denoted as “Beam ID=1” to “Beam ID=8” respectively. Similarly, in the example of Table 1-2, with still other 8 sets of phase-combinations, mean beams of different beam directions are provided as “Beam ID=9” to “Beam ID=16” respectively.

TABLE 1-1

| Beam ID | | 1 | 2 | 3 | 4 | 5 | 6 | 7 | 8 |
|---|---|---|---|---|---|---|---|---|---|
| UE V | 0 | 0 | 0 | 0 | 0 | 0 | 0 | 0 | 0 |
| | 1 | 0 | −45 | −315 | −135 | −225 | −135 | −225 | −225 |
| | 2 | −135 | −225 | −135 | −45 | −270 | 0 | −315 | −270 |
| | 3 | −135 | −270 | −45 | −135 | −180 | −90 | −180 | −135 |
| UE H | 4 | 0 | 0 | 0 | 0 | 0 | 0 | 0 | 0 |
| | 5 | −315 | 0 | −270 | −90 | −180 | −90 | −180 | −180 |
| | 6 | −180 | −180 | −90 | 0 | −225 | −315 | −270 | −225 |
| | 7 | −135 | −225 | 0 | −90 | −135 | −45 | −135 | −90 |

TABLE 1-2

| Beam ID | | 9 | 10 | 11 | 12 | 13 | 14 | 15 | 16 |
|---|---|---|---|---|---|---|---|---|---|
| UE V | 0 | 0 | 0 | 0 | 0 | 0 | 0 | 0 | 0 |
| | 1 | −135 | −315 | −225 | −315 | −180 | −135 | −90 | −270 |
| | 2 | −90 | −135 | −270 | −90 | −180 | −90 | 0 | −90 |
| | 3 | −225 | −315 | −90 | −270 | −315 | −180 | −90 | −270 |
| UE H | 4 | 0 | 0 | 0 | 0 | 0 | 0 | 0 | 0 |
| | 5 | −90 | −270 | −180 | −270 | −135 | −90 | −45 | −225 |
| | 6 | −45 | −90 | −225 | −45 | −135 | −45 | −315 | −45 |
| | 7 | −180 | −270 | −45 | −225 | −270 | −135 | −45 | −225 |

As mentioned above, the beam direction D-B of the radiation beam may be adjusted in a dimension (i.e., adjusted along the plane P1) with the beam steering mechanism. In addition, the beam direction D-B may be further adjusted in another dimension with aids of the actuator 300, as will be described in following paragraphs by reference to FIGS. 2B, 3, 4A and 4B.

FIG. 2B is a cross-sectional view of the actuator 300 and the first antenna array 200 of FIG. 2A. Referring to FIG. 2B (also, with FIG. 2A as a reference), the radiation end 250 of the group of antenna elements 210-240 of the first antenna array 200 faces toward the second direction D2. The second direction D2 has an angle Ø1 with respect to a third direction D3 (i.e., the third direction D3 is perpendicular to the first direction D1). With the view of FIG. 2A, the beam direction D-B of the radiation beam and the second direction D2 both lie on the same plane P1. Therefore, with the view of FIG. 2B the beam direction D-B of the radiation beam overlaps the second direction D2. That is, the angle between the beam direction D-B and the third direction D3 is equal to the angle Ø1.

In operation, the actuator 300 is configured to adjust first antenna array 200 to rotate along the first axis X1, so that the beam direction D-B of the radiation beam has a desired value of angle Ø1 with respect to the third direction D3. The angle Ø1 is adjusted according to the power of the RF signal RS1 from the remoted device 500, for example, according to RSSI and RSRP. The angle Ø1 is adjusted in a second range from 0 degree to 180 degree (i.e., the angle Ø1 is evaluated according to the cross-sectional view of FIG. 2B). In the example of FIGS. 2A and 2B, the angle Ø1 has a desired value of 90 degree (i.e., 90 degree is evaluated according to the cross-sectional view of FIG. 2B).

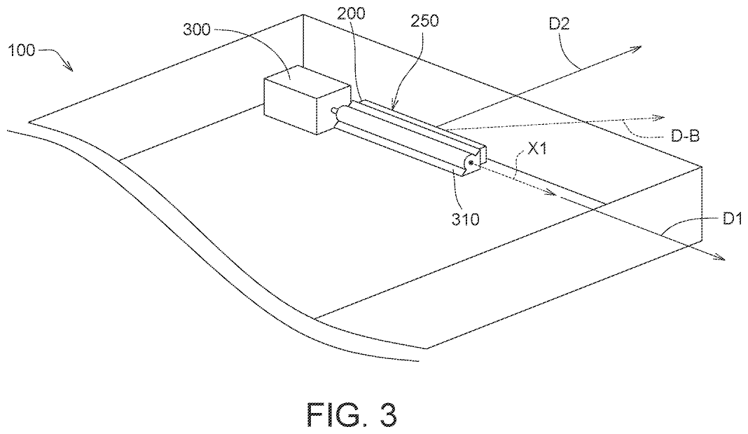

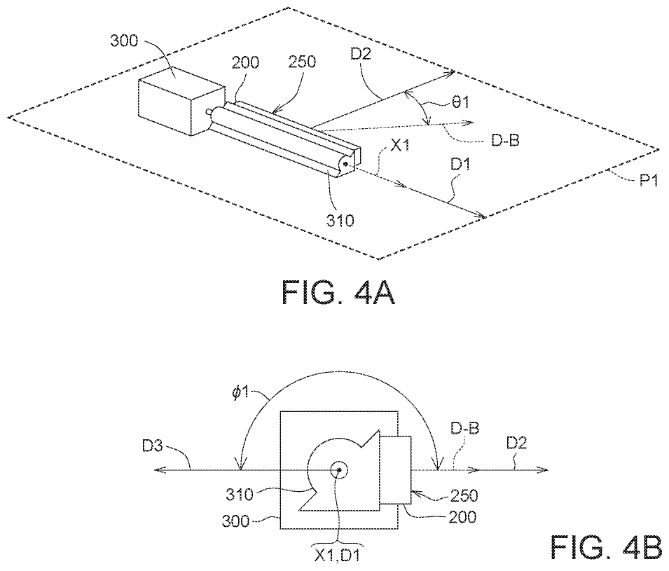

FIG. 3 is a schematic diagram of the radio device 100, in which the first antenna array 200 is adjusted to rotate along the first axis X1. FIG. 4A is an enlarged view of the actuator 300 and the first antenna array 200 of FIG. 3, and FIG. 4B is a cross-sectional view of the actuator 300 and the first antenna array 200 of FIG. 4A. Referring to FIGS. 3, 4A and 4B, the actuator 300 adjusts first antenna array 200 to further rotate along the first axis X1 so that angle Ø1 between the beam direction D-B of the radiation beam and the third direction D3 is 180 degree (i.e., 180 degree is evaluated according to the cross-sectional view of FIG. 4B).

Now referring to Tables 2-1 and 2-2 listed below, which describes another example of beam steering mechanism, given that the actuator 300 adjusts the first antenna array 200 to rotate as angle θ1=135 degree. That is, in the example of Tables 2-1 and 2-2, with 16 sets of phase-combinations, the radiation beam is steered as “Beam ID=17” to “Beam ID=32” with 16 different beam directions D-B having different angles θ1 along the plane P1, given that angle Ø1=135 degree with respect to the third direction D3.

TABLE 2-1

| Beam ID | | 17 | 18 | 19 | 20 | 21 | 22 | 23 | 24 |
|---|---|---|---|---|---|---|---|---|---|
| UE V | 0 | 0 | 0 | 0 | 0 | 0 | 0 | 0 | 0 |
| | 1 | −135 | −45 | −315 | −135 | −225 | −135 | −315 | −225 |
| | 2 | −45 | −225 | −135 | 0 | −270 | 0 | −135 | −270 |
| | 3 | −135 | −270 | −45 | −90 | −180 | −90 | −315 | −135 |
| UE H | 4 | 0 | 0 | 0 | 0 | 0 | 0 | 0 | 0 |
| | 5 | −90 | 0 | −270 | −90 | −180 | −90 | −270 | −180 |
| | 6 | 0 | −180 | −90 | −315 | −225 | −315 | −90 | −225 |
| | 7 | −90 | −225 | 0 | −45 | −135 | −45 | −270 | −90 |

TABLE 2-2

| Beam ID | | 25 | 26 | 27 | 28 | 29 | 30 | 31 | 32 |
|---|---|---|---|---|---|---|---|---|---|
| UE V | 0 | 0 | 0 | 0 | 0 | 0 | 0 | 0 | 0 |
| | 1 | −135 | −315 | −225 | −90 | −180 | −315 | −90 | −225 |
| | 2 | −90 | −135 | −270 | 0 | −180 | −90 | 0 | −270 |
| | 3 | −225 | −315 | −90 | −90 | −315 | −270 | −90 | −90 |
| UE H | 4 | 0 | 0 | 0 | 0 | 0 | 0 | 0 | 0 |
| | 5 | −90 | −270 | −180 | −45 | −135 | −270 | −45 | −180 |
| | 6 | −45 | −90 | −225 | −315 | −135 | −45 | −315 | −225 |
| | 7 | −180 | −270 | −45 | −45 | −270 | −225 | −45 | −45 |

Furthermore, referring to Tables 3-1 and 3-2 listed below, which describes still another example of beam steering mechanism, given that the actuator 300 adjusts the first antenna array 200 to rotate as angle Ø1=180 degree. In the example of Tables 3-1 and 3-2, the radiation beam is steered as “Beam ID=33” to “Beam ID=48” with different angles θ1 along the plane P1, given that angle Ø1=180 degree with respect to the third direction D3.

TABLE 3-1

| Beam ID | | 33 | 34 | 35 | 36 | 37 | 38 | 39 | 40 |
|---|---|---|---|---|---|---|---|---|---|
| UE V | 0 | 0 | 0 | 0 | 0 | 0 | 0 | 0 | 0 |
| | 1 | −45 | −45 | −315 | −135 | −225 | −90 | −315 | −225 |
| | 2 | −225 | −225 | −135 | 0 | −270 | 0 | −135 | −270 |
| | 3 | −270 | −270 | −45 | −90 | −180 | −90 | −315 | −135 |
| UE H | 4 | 0 | 0 | 0 | 0 | 0 | 0 | 0 | 0 |
| | 5 | 0 | 0 | −270 | −90 | −180 | −45 | −270 | −180 |
| | 6 | −180 | −180 | −90 | −315 | −225 | −315 | −90 | −225 |
| | 7 | −225 | −225 | 0 | −45 | −135 | −45 | −270 | −90 |

TABLE 3-2

| Beam ID | | 41 | 42 | 43 | 44 | 45 | 46 | 47 | 48 |
|---|---|---|---|---|---|---|---|---|---|
| UE V | 0 | 0 | 0 | 0 | 0 | 0 | 0 | 0 | 0 |
| | 1 | −135 | −315 | −135 | −90 | −135 | −315 | −90 | −135 |
| | 2 | −90 | −135 | −90 | 0 | −45 | −90 | 0 | 0 |
| | 3 | −225 | −315 | −180 | −90 | −135 | −270 | −90 | −90 |
| UE H | 4 | 0 | 0 | 0 | 0 | 0 | 0 | 0 | 0 |
| | 5 | −90 | −270 | −90 | −45 | −90 | −270 | −45 | −90 |
| | 6 | −45 | −90 | −45 | −315 | 0 | −45 | −315 | −315 |
| | 7 | −180 | −270 | −135 | −45 | −90 | −225 | −45 | −45 |

In the afore-mentioned examples, the group of antenna elements 210-240 of the first antenna array 200 performs beam steering mechanism to adjust the angle θ1 related to the beam direction D-B of the radiation beam. Furthermore, the actuator 300 adjusts the first antenna array 200 to rotate to adjust the angle Ø1 related to the beam direction D-B. In this manner, the beam direction D-B may be adjusted with two dimensions (i.e., angle θ1 and angle Ø1) to achieve better spherical coverage.

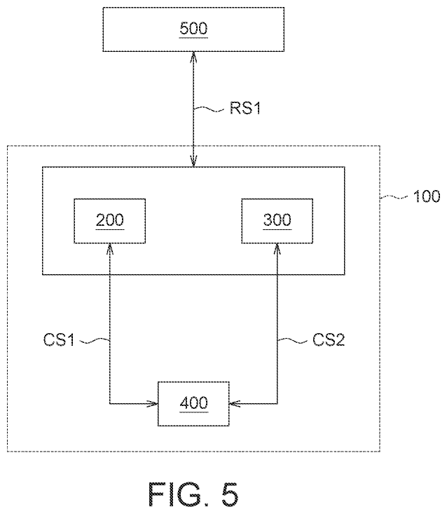

FIG. 5 is a block diagram illustrating signal flow of the radio device 100 and the remote device 500, and FIG. 5 is taken as a reference to illustrate a control method of the radio device 100 to adjust the radiation beam of the first antenna array 200. As shown in FIG. 5, the radio device 100 includes the first antenna array 200, the actuator 300 and a controlling unit 400. The control unit 400 is configured to control the first antenna array 200 to perform beam steering mechanism, according to the control signal CS1. Furthermore, the control unit 400 is configured to control the actuator 300 to adjust the first antenna array 200, according to the control signal CS2. Moreover, the radio device 100 transmits and receives the RF signal RS1 to and from the remote device 500, where the RF signal RS1 is carried by the radiation beam of the first antenna array 200. RSSI and/or RSRP related to the RF signal RS1 are evaluated by the radio device 100. Beam steering mechanism is performed according to the control signal CS1 and the RSSI and/or RSRP related to the RF signal RS1. Likewise, adjustment of the first antenna array 200 by the actuator 300 is performed according to the control signal CS2 and the RSSI and/or RSRP related to the RF signal RS1.

In another example (not shown) of the present disclosure, the actuator 300 is configured to change a position of the first antenna array 200, so as to move the first antenna array 200 away from obstacles (if any). For example, when a user of the radio device 100 puts his hand or fingers on the radio device 100, the hand or fingers will be obstacles to interfere radiation beam of the first antenna array 200. The actuator 300 may change a position of the first antenna array 200 to move away from user's hand or fingers.

For example, the radio device 100 has a case (not shown). The actuator 300 and the first antenna array 200 may be disposed near a first edge (not shown) of the case. The actuator 300 may change the position of the first antenna array 200 so that the first antenna array 200 moves with respect to the first edge of the case, and the first antenna array 200 may move away from obstacles on the case.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A radio device, comprising:
a first antenna array, configured to transmit a radiation beam to a remote device; and
an actuator, configured to change an orientation of the first antenna array, whereby a beam direction of the radiation beam is changed according to a change of the orientation of the first antenna array,
wherein the beam direction of the radiation beam is adjusted according to a beam steering mechanism performed by the first antenna array.

2. The radio device according to claim 1, wherein the beam direction of the radiation beam the beam steering mechanism based on at least one of a Received Signal Strength Indication (RSSI) and a Reference Signal Receiving Power (RSRP).

3. The radio device according to claim 1, wherein the first antenna array rotates with respect to a first axis, wherein the first axis is parallel to a first direction.

4. The radio device according to claim 3, wherein the first antenna array comprises a group of antenna elements, and the group of antenna elements are arranged to extend in the first direction.

5. The radio device according to claim 4, wherein the group of antenna elements have a radiation end facing toward a second direction, and the second direction is perpendicular to the first direction.

6. The radio device according to claim 5, wherein the beam direction of the radiation beam is adjusted along a plane defined by the first direction and the second direction.

7. The radio device according to claim 4, wherein the group of antenna elements are phase-array antenna elements.

8. The radio device according to claim 4, wherein each of the group of antenna elements has a vertical polarization or a horizontal polarization.

9. The radio device according to claim 1, wherein the radio device has a case, the actuator and the first antenna array are disposed near a first edge of the case.

10. The radio device according to claim 9, wherein the actuator is further configured to change a position of the first antenna array, so that the first antenna array moves with respect to the first edge of the case.

11. A control method for controlling a radiation beam of a radio device, the radio device includes a first antenna array to transmit the radiation beam to a remote device, and the control method comprising:
controlling an actuator to change an orientation of the first antenna array, whereby a beam direction of the radiation beam is changed according to a change of the orientation of the first antenna array; and
controlling the first antenna array to perform a beam steering mechanism to adjust the beam direction of the radiation beam.

12. The control method according to claim 11, wherein the beam direction of the radiation beam is adjusted according to the orientation of the first antenna array and the beam steering mechanism based on a Received Signal Strength Indication (RSSI) and/or a Reference Signal Receiving Power (RSRP) related to the remote device and the radio device.

13. The control method according to claim 11, wherein the actuator changes the orientation of the first antenna array so that the first antenna array rotates with respect to a first axis, wherein the first axis is parallel to a first direction.

14. The control method according to claim 13, wherein the first antenna array comprises a group of antenna elements, and the group of antenna elements are arranged to extend in the first direction.

15. The control method according to claim 14, wherein the group of antenna elements have a radiation end facing toward a second direction, and the second direction is perpendicular to the first direction.

16. The control method according to claim 15, wherein the beam steering mechanism is performed to adjust the beam direction of the radiation beam along a plane defined by the first direction and the second direction.

17. The control method according to claim 11, wherein the radio device has a case, the actuator and the first antenna array are disposed near a first edge of the case, and the control method further comprises:
controlling the actuator to change a position of the first antenna array, so that the first antenna array moves with respect to the first edge of the case.
